(19) United States
(12) Patent Application Publication
(10) Pub. No.: US 2026/0238905 A1
(43) Pub. Date: Aug. 13, 2026

(54) CHANNELIZED FRAMING STRUCTURE TO SUPPORT CONSTANT BIT RATE TRAFFIC IN AN OPTICAL NETWORK ENVIRONMENT

(71) Applicant: Cisco Technology, Inc., San Jose, CA (US)

(72) Inventors: Gilberto Loprieno, Milano (IT); James A. Duda, Boylston, MA (US); Markus F. Weber, Weinolsheim (DE); Michael A. Sluyski, Bolton, MA (US)

(21) Appl. No.: 19/051,494

(22) Filed: Feb. 12, 2025

(51) Int. Cl. H04Q 11/00

(52) U.S. Cl. CPC H04Q 11/0067; H04Q 2011/0083; H04Q 2011/0086

(57) ABSTRACT

Provided herein are techniques to facilitate the transport of constant bit rate (CBR) data, such as Ethernet data, optical transport network (OTN) data, and/or the like through a flexible OTN (FlexO) optimized for Ethernet (FlexO-Xe) frame structure that utilizes 5 Gigabit per second (Gbit/s) time slots. In at least one embodiment, a computer implemented method is provided that may include mapping at least one of Ethernet data or OTN data into a FlexO-Xe frame structure that includes 5 Gbit/s time slot blocks for a predetermined number of channelized FlexO-Xe data frames to support transmission data rates greater than 1 Terabit per second. Different Ethernet and OTN data FlexO-Xe mapping techniques are provided through embodiments herein. The at least one of the Ethernet data or the OTN data mapped into channelized FlexO-Xe data frames can be transmitted from a source device to a destination device via at least one optical network link.

### TECHNICAL FIELD

The present disclosure relates to network equipment and services.

### BACKGROUND

The International Telecommunication Union Telecommunication Standardization Sector (ITU-T) has developed a series of optical transport network (OTN) standards, such as the G.709.1 standard, that provides details that define the physical layer, signal rate, format, and equipment requirements for transmitting/receiving data across optical fiber channels. The ITU-T standardized frame structure for transporting OTN data is typically referred to as the flexible optical transport network (FlexO) frame structure. With the development of high data rate architectures, such as Beyond 1 Terabyte (BIT) architectures, opportunities exist to develop new solutions that support transport of different types of data or traffic over an optical network at BIT transmission rates.

### BRIEF DESCRIPTION OF THE DRAWINGS

FIG. 1 is a block diagram of a system configured for the transmission and reception of data frames via one or more optical links, according to an example embodiment.

FIG. 2 is a schematic diagram illustrating an example flexible optical transport network (OTN) optimized for ethernet (FlexO-Xe or FlexO.Xe) frame structure including 5 Gigabit per second (5 Gbit/s) time slot blocks that can be used for transporting constant bit rate (CBR) data, according to an example embodiment.

FIG. 3 is a schematic diagram illustrating example details for sixteen (16) channelized FlexO.1e data frames (FlexO.16e) including using 5 Gbit/s time slot blocks that can be used to support 1.6 Terabit per second Ethernet data transport, according to an example embodiment.

FIG. 4 is a diagram illustrating example Ethernet data frame mapping details when utilizing channelized FlexO.16e data frames including 5 Gbit/s time slot blocks for transporting Ethernet data, according to an example embodiment.

FIG. 5 is a diagram illustrating example OTN data frame mapping details when utilizing channelized FlexO.16e data frames including 5 Gbit/s time slot blocks to facilitate transporting OTN data, according to an example embodiment.

FIG. 6 is a block diagram of a system illustrating example operations that may facilitate measuring round trip latency when transporting OTN data via channelized FlexO.Xe data frames, according to an example embodiment.

FIG. 7 is a flow chart depicting a method according to an example embodiment.

FIG. 8 illustrates a hardware block diagram of a network device configured to perform functions associated with operations discussed in connection with embodiments herein.

### DETAILED DESCRIPTION

### Overview

Embodiments presented herein provide for the ability to transport constant bit rate (CBR) data, such as Ethernet data, optical transport network (OTN) data, and/or the like through a flexible OTN (FlexO) optimized for Ethernet (FlexO-Xe) frame structure that utilizes 5 Gigabit per second time slots.

In at least one embodiment, a computer-implemented method is provided that may include mapping at least one of Ethernet data or OTN data into a FlexO-Xe frame structure including 5 Gigabit per second time slot blocks for a predetermined number of channelized FlexO-Xe data frames (e.g., 16 FlexO-Xe frames or FlexO.16e) to support transmission data rates greater than 1 Terabit per second.

For Ethernet data, the mapping may include mapping the Ethernet data into groups of a predetermined number of time slot blocks (e.g., groups of 20 time slot blocks) provided over each of the predetermined number (e.g., 16) of channelized data frames.

For OTN data, the mapping may include mapping the OTN data into the groups of the predetermined number of time slot blocks provided over a predetermined subset of channelized data frames of the predetermined number of channelized data frames (e.g., OTN data being mapped into 20 time slot blocks for a given group number of 15 channelized FlexO-Xe data frames) and mapping additional OTN data associated with each of the predetermined subset of channelized data frames into an additional time slot block of at least one remaining channelized data frame of the predetermined number of channelized data frames (e.g., additional OTN data associated with each of the 15 channelized FlexO-Xe being mapped into a 21^{st} time slot block for the given group number for the 16^{th} channelized data frame). Each time slot block may include 5 Gigabit per second of the Ethernet data or the OTN data. The method may further include transmitting at least one of the Ethernet data or the OTN data via an optical network link.

In at least one embodiment, the FlexO-Xe frame structure including the 5 Gbit/s time slot blocks may support mapping any constant bit rate (CBR) data into the predetermined number of channelized data frames.

### Example Embodiments

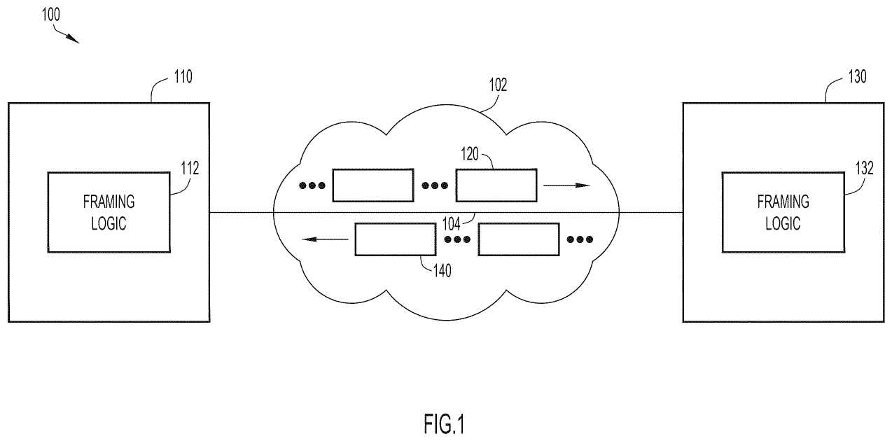

Referring to FIG. 1, FIG. 1 is a block diagram of a system 100 that may be configured for the transmission and reception of data frames via one or more optical links. For example, as shown in FIG. 1, a number of network devices, including a network device 110 and a network device 130 can be provided in the system 100. Network device 110 can include framing logic 112 and network device 130 can include framing logic 132. Network device 110 and network device 130 can interface via a network 102 and one or more optical links, such as an optical link 104, as shown in FIG. 1.

Each network device 110, 130 is configured to transmit and receive data frames via the optical link 104 by mapping (via their respective framing logic 112, 132) constant bit rate (CBR) data, such as Ethernet data, optical transport network (OTN) data, and/or any other CBR into data frames for transmission via the optical link. For example, in accordance with embodiments herein, network device 110, via framing logic 112, can map CBR data into data frames 120 that are transmitted via the optical link 104 and received by network device 130 in which the data frames 120 are demapped, via framing logic 132, to obtain or recover the CBR data carried in the data frames 120 such that the CBR data can be utilized for other processes, communications, etc. In the transmission example involving data frames 120, network device 110 can be characterized as a source or ‘near end’ device and network device 130 can be characterized as a destination or ‘far end’ device.

Similarly, network device 130, via framing logic 132, can map CBR data into data frames 140 that are transmitted via the optical link 104 and received by network device 110 in which the data frames 140 are demapped, via framing logic 112, to obtain the CBR data carried in the data frames 140 such that the CBR data can be utilized for other processes, communications, etc. In the transmission example involving data frames 140, network device 130 can be characterized as a source or ‘near end’ device and network device 110 can be characterized as a destination or ‘far end’ device.

Thus, it is understood that the terms source/near end device and destination/far end device as used for discussions herein are relative terms depending on the network device transmitting data frames and the network device receiving the data frames. In some instances, a network device can be referred to as a ‘client’ for discussions herein. As referred to herein, the terms ‘data’ and ‘traffic’ can be used interchangeably in reference to data frames that may be transmitted/received by devices.

In accordance with embodiments herein, data frames transmitted/received via one or more optical links, such as data frames 120/140, can be constructed to conform to an information or frame structure such as the flexible optical transport network optimized for Ethernet (referred to interchangeably herein using the terms ‘FlexO-Xe’ and ‘FlexO.Xe’) frame/information structure. In at least one embodiment, framing logic 112 of network device 110 and framing logic 132 of network device 130 may be implemented via an N number of Generic Mapping Procedure (GMP) controllers to facilitate mapping/demapping operations. Further, embodiments herein may provide mapping schemes through which channelized FlexO-Xe data frames can be utilized to carry any type of CBR data/traffic, such as Ethernet data, optical transport network (OTN) data (such as optical data unit level 4 (ODU4), optical transport unit level 4 (OTU4), 16/32/64/128/etc. Gigabit Fibre Channel (16GFC, 32GFC, 64GFC, 128GFC, etc.) data, and/or the like, utilizing groups of time slots in which each time slot is configured with a granularity of approximately 5 Gigabits per second (Gbit/s) for transporting CBR data.

For discussions herein with reference to one or more instances of channelized FlexO-Xe, a labeling scheme ‘FlexO-ne’ or ‘FlexO.ne’ is utilized in which ‘n’ is used to represent an ‘n’ instance number of channelized FlexO-Xe data frame instance(s), or simply channelized FlexO-Xe instances. For example, FlexO.1e can be used to represent one channelized FlexO-Xe instance, FlexO.16e or FlexO-16e can be used to represent 16 FlexO.1e instances, and so on. As referred to herein, the terms ‘time slots’ and ‘time slot blocks’ can be used interchangeably.

Optical network standards setting organizations, such as the International Telecommunication Union (ITU), the Optical Interworking Forum (OIF), the Open Reconfigurable Optical Add Drop Multiplexer (OpenROADM) group, and the like are starting to explore/standardize Beyond 1 Terabyte (BIT) solutions, such a 1.6 Terabit per second (1.6 T) solutions/architectures/interfaces.

Current BIT solutions are based a channelized framing scheme involving a grouping of sixteen (16) channelized FlexO-Xe data frames (FlexO-16e or FlexO.16e) with 100 Gbit/s time slots for transporting Ethernet data.

However, there are limitations when using the standards-based FlexO-Xe frame structure with 100 Gbit/s time slots for transporting other types of data, such as OTN ODU4 client data. For example, ODU4 data (or ODUCn data (where ‘C’ corresponds to Roman numeral 100 and ‘n’ corresponds to an ODUC instance or slice)) cannot be transported over a single FlexO-Xe because transport of ODU4 data for a client requires a data rate of approximately 105 Gbit/s, depending on the coding format, while a channelized FlexO-Xe instance supports a data rate of approximately 100 Gbit/s coded 256/257 (100GE coded 256/256 is running at 100.390625 Gbit/s (+/−100 ppm), before it is transmitted Forward Error Correction (FEC) Reed-Solomon (RS) (514, 544) is added and it is transmitted at 106.250 Gbit/s).

In order to address such limitations, embodiments herein provide frame mapping techniques that support mapping CBR data (e.g., Ethernet data, ODU4 data, etc.) into a predetermined number of channelized FlexO-Xe data frames (instances) that are spit into time slots having a granularity or channelization of approximately 5 Gbit/s. In at least one embodiment, the predetermined number of channelized data frames may be set to 16 (e.g., FlexO.16e) in which, for time slot blocks provided at the granularity of 5 Gbit/s, can be referred to herein as ‘FlexO-16e.5Gts’.

In at least one embodiment, sets or groups of a predetermined number of 5 Gbit/s time slot blocks for each channelized FlexO-Xe data frame instance can be used for transporting such CBR data. In at least one embodiment each group of time slot blocks can include 20 time slot blocks.

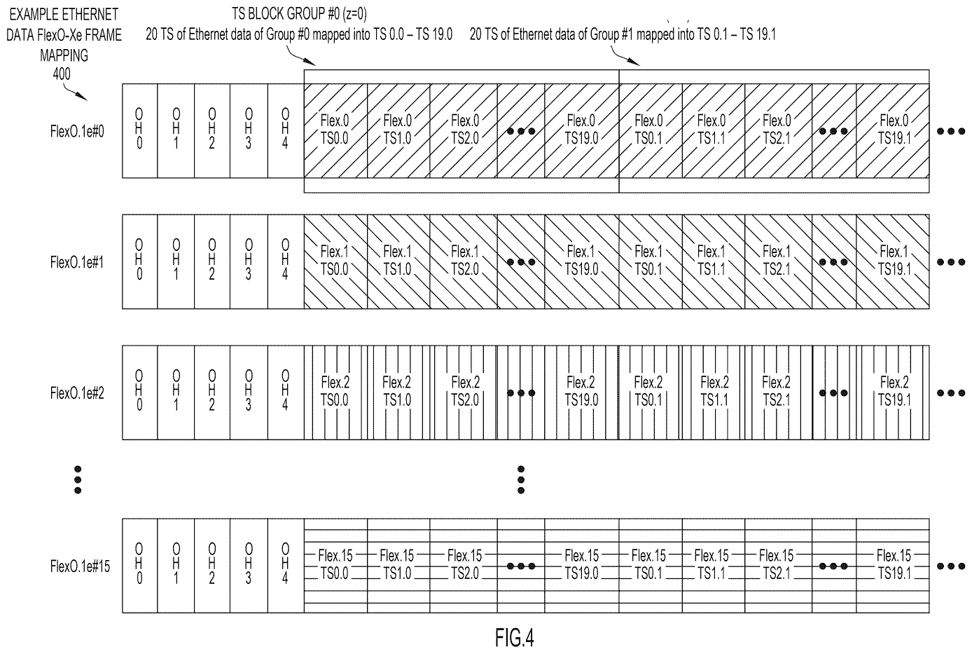

When mapping Ethernet into the FlexO-Xe frame structure at the 5 Gbit/s granularity as provided by embodiments herein, 20 time slot blocks can be used to carry the channelized Ethernet data; whereas, when mapping ODU4 data into the FlexO-Xe frame structure at the 5 Gbit/s granularity as provided by embodiments herein, 21 time slot blocks can be used to carry the channelized ODU4 data. Additional details for mapping Ethernet data or ODU4 across 16 channelized FlexO.1e instances are provided herein below, for example, with reference at least to FIG. 4.

Each time slot block can be 257 bits (optimized to transport Ethernet traffic coded at 256/257b). In at least one embodiment, ODU4 data can be transported in time slot blocks using 256 bits (32 bytes) in which each 256-bit data block is followed by a 1-bit stuffing bit that can be used to preserve byte alignment. The stuffing bit can be used for measuring round trip latency in at least one embodiment. In at least one embodiment, the 1-bit stuffing bit may not be used such that 257 bits of ODU4 data can be included in each time slot block.

In this manner, a mix of OTN and Ethernet traffic, or more generally, a mix of any CBR traffic, can be transported with a negligible inefficiency for OTN transport. Through embodiments herein, the ODUCn management/mapping layer, typically utilized for mapping ODU4 data into data frames, can be removed because OTN or CBR traffic can be efficiently mapped, using OTN GMP mapping, over FlexO-Xe.

An advantage of 5 Gbit/s time slot granularity is the “obsolescence” of the ODUCn layer because ODU4 data can be GMP mapped over FlexO-Xe data frames in accordance with embodiments herein without need of the ODUCn layer. The FlexO-ne payload is segmented into M time slots, each transporting around 5 Gbit/s of bandwidth, such that at any clients (e.g., Ethernet, ODU4)/any CBR traffic can be efficiently mapped over an ‘N’×5 Gbit/s time slots in accordance with embodiments herein.

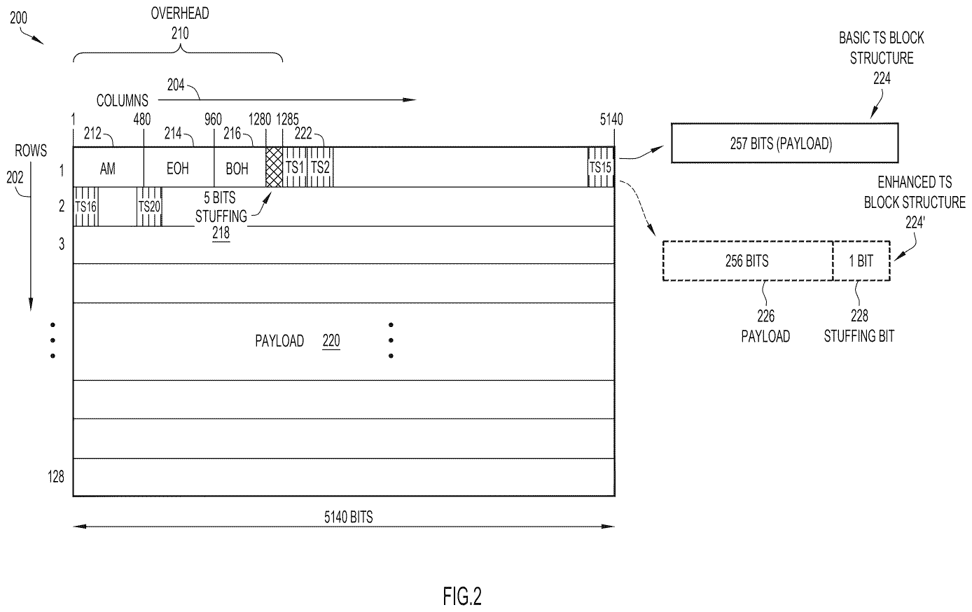

With reference to FIG. 2, FIG. 2 is a schematic diagram illustrating an example FlexO-Xe frame structure 200 including 5 Gbps time slot (TS) blocks 222 for a payload portion 220 of the FlexO-Xe frame structure into which CBR data can be mapped using GMP for transport via at least one optical link, according to an example embodiment.

The basic, standards-based layout of the FlexO-Xe frame structure 200 is defined by ITU-T G.709.1 and is organized in a row 202 and column 204 format in which 128 rows are provided, each row including 5140 bits. The first row (Row 1) of the FlexO-Xe frame structure 200 includes a header portion 210 including a 480-bit Alignment Marker (AM) field 212, a 480-bit Extended Overhead (EOH) field 214, and a 480-bit Basic Overhead (BOH) field 216. In accordance with embodiments herein, a 5-bit stuffing bit field 218 is also provided for the overhead portion 210, bringing the total number of overhead bits to 1285 bits. It is noted that the transmission order for the FlexO-Xe frame structure 200 is from left to right (column 1 (bit 1)->column 5140 (bit 5140) and then from top to bottom (row 1->row 128).

Each 5 Gbit/s time slot block 222 is configured as a 257-bit (257 b) TS block. As shown in FIG. 2, a basic TS block structure 224 can be provided in some embodiments that includes 257 bits of payload (data). For Ethernet data, 5 Gbit/s time slot blocks can be coded using a 256/257 coding.

In at least one embodiment for OTN data (e.g., ODU4 data), the basic TS block structure 224 can be configured to carry 257 bits of OTN data. In at least one alternate embodiment for OTN data, an enhanced TS block structure 224′ can be provided that includes a 256-bit payload portion 226 and a 1-bit stuffing bit portion 228. For example, OTN data (e.g., ODU4 data) can be transported using the enhanced TS block structure 224′ in which each 256-bit payload portion of ODU4 data is followed by the 1-bit stuffing bit to preserve byte alignment.

Using 257-bit time slot blocks as provided by embodiments herein for data transport, 15 time slot blocks can be carried in the first row of the FlexO-Xe frame structure 200 (5140b−1285b (OH)=3855; 3855/257=15), meaning that the overhead portion 210 effectively consumes 5 time slot blocks, if organized in a similar 257-bit manner.

Each of the remaining rows of the FlexO-Xe frame structure 200 can carry 20 time slot blocks for a total payload capacity of 2555 time slot blocks (20 TS blocks×127 rows=2540+15 TS blocks for Row 1=2555 TS blocks).

Per ITU-T G.709.1, the FlexO-ne bit rate is approximately: n×100 622 438.327 kilobits per second (kbits/s), for an ‘n’ number of FlexO-Xe instances. Using the 5 Gbit/s 257-bit time slot block structure as provided by embodiments herein resulting in a payload of 2555 time slot blocks (each time slot block being 257-bits), the FlexO-Xe frame structure 200 can support a bandwidth of 100.425910127 Gbit/s, with each time slot block supporting 5.021295506 Gbit/s of data payload.

The 5 Gbit/s time slot blocks 222 can be organized in groups or sets of 20 time slot blocks, thereby supporting a 100 Gbit/s data payload in each time group of time slot blocks. As referred to herein a time slot (time slot block) number can be referenced using an index ‘y’ and a time slot block group number can be referenced using an index ‘z’ such that each time slot block can be labeled using a ‘y.z’ label. In one sense, the ‘z’ time slot block group number can represent the time slot block numbering scheme for the standards-based 100 Gbit/s channelization of FlexO-Xe data frames. For example, TS ‘y.z’, where z=number of a group of Time Slots and y=0-19 for the number of time slots of each FlexO-1e (each FlexO-xe has 20 time slots).

Utilizing the 5 Gbit/s time slot blocks as provided by embodiments herein, a single 100 Gigabit Ethernet (100GE) client will continue to fit in a single FlexO-Xe instance (i.e., will use all 20 time slots for each group of time slot blocks).

However, transport for OTN data, such as ODU4 data involving 105 Gbit/s of data, will utilize 21 5 Gbit/s time slots, which may not be efficiently mapped into a single FlexO.1e instance using the demarcation of 20 time slot block groups of data. Yet, FlexO.16e can support 320 total time slots across each 20-time slot block group number for 16 FlexO.1e data frame instances (e.g., time slot block group number ‘0’ for each FlexO.1e instance supports 20 time slot blocks such that 16×20=320). Thus, in accordance with the frame mapping schemes provided through embodiments herein, up to 15 ODU4 (105 Gbit/s) containers can be transported using FlexO.16e.

When utilizing the enhanced TS block structure 224′, ODU4 coded 256/257 requires 105.2038 Gbit/s, which split over 21 time slot blocks equates to time slot blocks of approximately 5.009705 Gbit/s. As noted above, the FlexO-Xe frame structure 200 as configured in accordance with embodiments herein supports time slot blocks of 5.021295506 Gbit/s, which provides enough bandwidth to transport ODU4 coded 256/257 (with one stuffing bit) (e.g., supported 5.021295506 Gbit/s>required 5.009705 Gbit/s).

Accordingly, use of 257-bit time slot blocks may be optimized for Ethernet data but can also be efficiently used for any other protocol, thereby allowing mixed CBR traffic (e.g., Ethernet and OTN) multiplexing. Further, using the 5 Gbit/s time slot block granularity as provided by the FlexO-Xe frame structure 200 can support the efficient mapping of any CBR traffic (e.g., Ethernet, OTU4/ODU4, 16/32/64/128GFC, etc.) without use of the ODUCn layer.

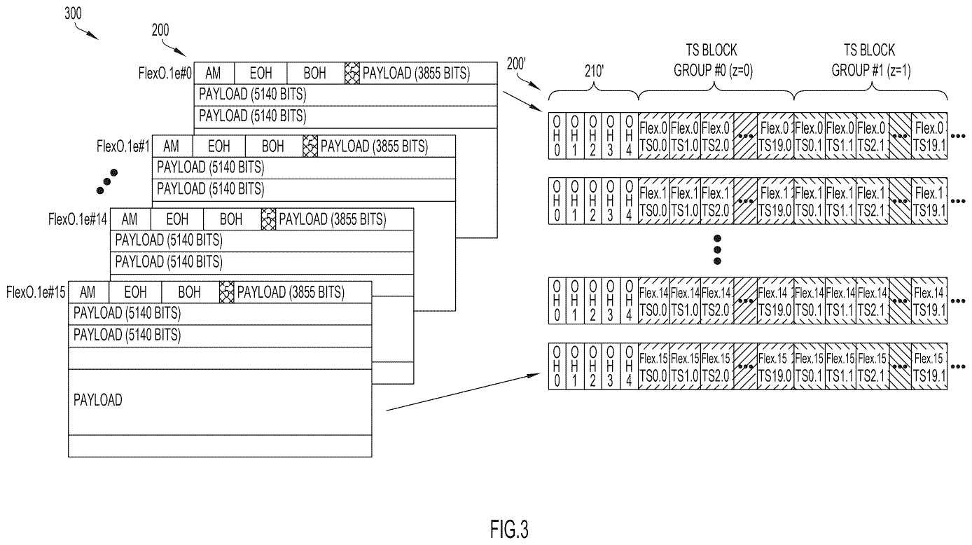

In accordance with embodiments herein, different modes or techniques can be utilized to assign or map time slots to single client (e.g., network device 110 or network device 130 of FIG. 1) utilizing the FlexO-Xe frame structure 200 of FIG. 2 for transport of CBR data associated with the client, as discussed with reference to FIGS. 3, 4, and 5, below.

Moving to FIG. 3, FIG. 3 is a schematic diagram 300 illustrating example details for 16 channelized FlexO.1e data frames (FlexO.16e) including using 5 Gbit/s time slot blocks that can be used to support 1.6 Terabit per second Ethernet data transport, according to an example embodiment.

Generally, FIG. 3 illustrates 16 instances of the FlexO-Xe frame structure 200 of FIG. 2 represented across 16 interleaved instances channelized FlexO.1e data frames (conventionally referred to as FlexO.16e), shown as logical channels numbered #0 thru #15, e.g., ‘FlexO.1e #0’, ‘FlexO.1e #1’, thru ‘FlexO.1e #15’.

For FIG. 3, the channelized FlexO.1e data frames are also illustrated in a format 200′ such that columns 1-128 for each frame can be visualized as contiguous 5 Gbit/s time slot blocks. For format 200′, the overhead portion of each frame is shown in a 5 Gbit/s time slot block format 210′ such that the overhead data and 5 stuffing bits for each data frame (e.g., AM field 212, EOH field 214, BOH field 218, and stuffing bit field 218, as shown in FIG. 2) can mapped into 5 time slot (TS) blocks, numbered OH0, OH1, OH2, OH3, and OH4.

As noted above, a time slot (time slot block) number can be referenced using an index ‘y’ and a time slot block group number can be referenced using an index ‘z’ such that each time slot block can be labeled using a ‘y.z’ label.

As shown in FIG. 3, two time slot block groups are shown for each channelized FlexO.1e instance, a time slot block group #0, split over 20 time slots numbered TS0.0 thru TS0.19, and a time slot block group #1, also split over 20 time slots numbered TS0.1 thru TS0.19. It is to be understood that additional time slot block groups are provided across time for each of the 16 channelized FlexO.1e data frame instances (e.g., thru row 128) and, further, across additional Flex.1e data frames for each channel (e.g., for additional FlexO-Xe frames of CBR data to be transported for the client).

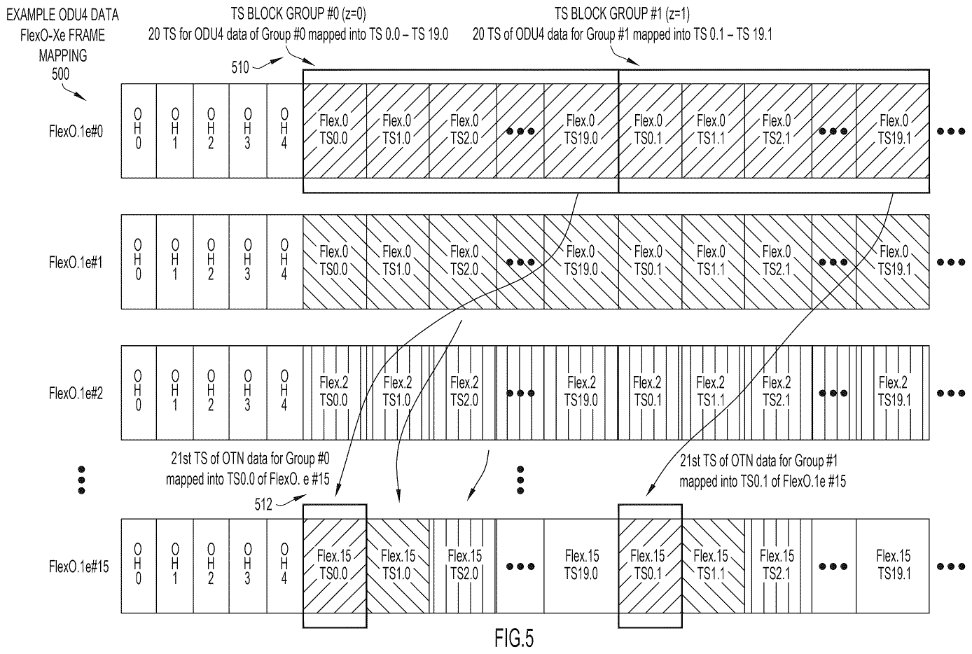

Different example frame mapping schemes for mapping different types of CBR data into the 5 Gbit/s times slots and time slot block groups across channelized FlexO.16e data frames will now be discussed with reference to FIG. 4 and FIG. 5.

With reference to FIG. 4, FIG. 4 is a diagram 400 illustrating example Ethernet data frame mapping details when utilizing channelized FlexO.16e data frames including 5 Gbit/s time slot blocks for transporting Ethernet data, according to an example embodiment.

As shown in FIG. 4, each FlexO.1e is split over groups of 20 time slots such that each FlexO.1e is dedicated to transport a single 100GE (coded 256/257). It is noted that 400GE can be mapped over 4×FlexO.1e instances.

Utilizing the FlexO-Xe frame structure 200 with 5 Gbit/s time slots facilitates mapping of Ethernet data into channelized FlexO.1e frames over 20 5 Gbit/s time slots at an Ethernet optimized frequency to facilitate 100GE transmission for each FlexO.1e instance. In particular, the FlexO-Xe frame structure 200 for transporting 256/257 coded Ethernet data may support a bandwidth of 100.425910127 Gbit/s with each time slot supporting 5.021295506 Gbit/s of data payload.

Thus, as illustrated in FIG. 4, utilizing 16 channelized FlexO.1e instances each facilitating 100GE can be used to transport 1.6 Terabit/s (1.6 T) of Ethernet data for a given client.

Additional frame mapping/demapping details utilizing the FlexO-Xe frame structure 200 with 5 Gbit/s time slots, such as providing various enhanced Multiplex Structure Identifier (MSI) configurations and enhanced Justification Control (JC) configurations can be utilized to inform/configure mapping and recovery (demapping) operations for transmitting and receiving FlexO-Xe data frames utilizing the 5 Gbit/s time slot blocks as provided herein are discussed in further detail below with reference to FIG. 5.

Moving to FIG. 5, FIG. 5 is a diagram 500 illustrating example OTN data frame mapping details when utilizing channelized FlexO.16e data frames including 5 Gbit/s time slot blocks (also referred to herein FlexO.16e.5ts) to facilitate transporting OTN data, such as ODU4 data, according to an example embodiment.

As noted above, ODU4, which requires 105 Gbit/s, can be transported using 21 5 Gbit/s time slots (coded 256/257). In accordance with embodiments herein, a frame mapping scheme as shown in FIG. 5 can be provided that enables 15 channelized ODU4 105 Gbit/s containers (15×ODU4) to be transported utilizing FlexO.16e.5ts in order to facilitate transport of approximately 1.575 Gbit/s of ODU4 data for a given client.

As shown in FIG. 5, in one example frame mapping scheme, ODU4 data for the first 20 time slots for each time slot block group of a subset of channelized FlexO.1e data frames of the 16 channelized FlexO.1e data frames, such as each of logical channels #0-#14 of the 16 channelized FlexO.1e instances (15 FlexO.1e instances of the 16 total FlexO.1e instances), can be GMP mapped into each of time slot of each time slot block group with the remaining 21^{st} time slot of ODU4 data being mapped into corresponding time slots of the corresponding time slot block group of FlexO.1e #15. In essence, FlexO.1e #15 can be used to “loan” 5 Gbit/s time slots to each of FlexO.1e #0 thru #14 in the example frame mapping scheme shown in FIG. 5.

For example, as shown in FIG. 5, 20 5 Gbit/s times slots of ODU4 data can be mapped into TS0.0 thru TS19.0 of time slot block group #0 for FlexO.1e #0, as generally shown at 510, and the 21^{st} time slot block of ODU4 data for FlexO.1e #0 associated with group #0 can be mapped into TS0.0 of FlexO.1e #15, as generally shown at 512.

ODU4 data for each of FlexO.1e #1 thru FlexO.1e #14 can be mapped into the channelized FlexO-Xe data frames #1 thru #14 and #15 in a similar manner. Although not shown in FIG. 5, time slots 16.0, 17.0, 18.0, and 19.0 of FlexO.1e #15 (and also of other group numbers) are not used and can be filled by stuffing bits, such as a fixed pattern or the like.

The example frame mapping as illustrated in FIG. 5 involving 21 5 Gbit/s TS may support an overall bandwidth of 105.4472 Gbit/s of ODU4 data (coded 256/257) that is greater than the nominal required bandwidth for ODU4, which is 104 794 445.815 kbit/s, as well as the ODU4 (coded 256/257) bandwidth, which is 105.2038 Gbit/s, as noted above.

It is noted as per G.709.1 FlexO frame structure is based on a multiframe composed of 8 FlexO frames. Specifically, FlexO-1e is composed of 2555 blocks of 257 bits. A multiframe structure based on 8 FlexO-Xe frames supports 20440×257 blocks (each of 257 bits) or 1022 block of 20× blocks. After a FlexO-xe multiframe, the time slots are in the position they were in the previous multiframe. Thus, supporting BIT using a multiframe based on 8 FlexO-xe frames aligns with what is specified by G.709.1.

Regarding GMP mapping, recall from FIG. 2 that the FlexO-Xe frame structure 200 supports 2555 5 Gbit/s time slot blocks per 100 G data frame instance or slice. Thus, over 16 slices (i.e., FlexO.16e) utilizing the FlexO-Xe frame structure 200, 40880 time slot blocks (16×2555=40880) are available for carrying OTN ODU4 data. Over an 8 frame multiframe, 327040 time slot blocks are available (40880×8=327040).

Per the existing G.709.1 FlexO-Xe frame structure, each 100 G slice has GMP overhead across 8 frames, which equates 16 (or N) unique GMP controllers (e.g., provided via framing logic 112/132).

Utilizing the channelized FlexO-Xe frame structure 200 utilizing 5 Gbit/s time slot blocks, each time slot block is to be locked to one of 16 (or N) unique GMP controllers. For N=16, 20, 4-bit identifiers (i.e., log 2 (N)=4) are needed to map each time slot block to a GMP controller in each slice. Thus, 80 bits or 8 bytes can be used to store the GMP controller mapping for each time slot block.

For example, in at least one embodiment, it is possible to use a fixed mapping between tributary ports and tributary slots (for example, 16×100GE or 15×ODU4) such that source/destination network devices can map/demap FlexO-Xe data frames provided in accordance with embodiments herein. For example, in at least one embodiment, fixed time slots can be assigned across a number channelized FlexO-Xe data frame instances (e.g., #0-#15 for 16 data frame instances) in order to map/demap data across 320 time slot blocks (e.g., 16×20) of each time slot block group number (index ‘z’, noted herein) available for transporting different types of data, as follows:

### Ethernet Data

Ethernet: 100GE #0=>TS0 thru TS19 (for TS block group #0);
Ethernet: 100GE #1=>TS20 thru TS39 (for TS block group #1);
. . .
Ethernet: 100GE #15=>TS300 thru TS319 (for TS block group #15).

### OTN DATA

ODU4 #0=>TS0 thru TS19+TS300 (for TS block group #0);
ODU4 #1=>TS20 thru TS39+TS301 (for TS block group #1);
. . .
ODU4 #14=>TS280 thru TS299+TS 314 (for TS block group #0).

However, strict assignment of time slot blocks across GMP mapping/demapping controllers, such as those illustrated above, may limit flexibility of the techniques provided herein.

As such, various enhanced Multiplex Structure Identifier (MSI) configurations can be provided to facilitate the use of 5 Gbit/s time slots per the FlexO-Xe frame structure 200 of FIG. 2, in accordance with embodiments herein. In various embodiments, such MSI configurations be utilized to configure framing logic (e.g., GMP controllers) of network devices to facilitate mapping and recovery (demapping) operations for transmitting and receiving FlexO-Xe data frames utilizing the 5 Gbit/s time slot blocks as provided herein.

Embodiments herein may support the use of 20 bytes (one for each time slot) as multiplexing identifiers for each FlexO-e. A FlexO-MSI.ts configuration may be utilized in in some embodiments to increase the flexibility of time slot assignments.

Each channelized FlexO-Xe frame including 5 Gbit/s time slots is based on a multiframe (8×) and has multiple RESERVED (RES) bytes not used (for example, BOH bytes 29-40). For example, for N=16, there are 8 bytes of RES available. For N>16, more bits will be needed for GMP controller lookup.

In at least one embodiment, it is proposed to populate each FlexO-Xe overhead portion by adding a 20 Byte FlexO-MSI.ts configuration that can be used to inform a destination network device regarding the mapping of data across 5 Gbit/s time slots.

Although 3 RESERVED bytes may be used for each FlexO-Xe frame, by using an 8 frame multiframe, up to 24 bytes can be assigned. An example of such time slot assignment as may be provided via a FlexO-MSI.ts configuration in accordance with embodiments herein is shown below in TABLE 1, where a given column #of the FlexO-Xe frame structure 200 is referenced as ‘Col-#’.

TABLE 1
EXAMPLE TS ASSIGNMENTS

| FlexO-Xe | Col-29 | Col-30 | Col-31 |
|---|---|---|---|
| 000 | TS0 | TS1 | TS2 |
| 001 | TS3 | TS4 | TS5 |
| 010 | TS6 | TS7 | TS8 |
| 011 | TS9 | TS10 | TS11 |
| 100 | TS12 | TS13 | TS14 |
| 101 | TS15 | TS16 | TS17 |
| 110 | TS18 | TS19 | TS20 |
| 111 | CSF0 | CFP1 | CFP2 |

In at least one embodiment, a given time slot, ‘TS-j’ can be used to transport FlexO-MSI.j information. When a given time slot is not used, the FlexO-MSI.ts for that time slot can be filled by all zeros (00000000). When a given time slot is used, the FlexO-MSI.ts for that time slot can filled by the tributary port number.

In at least one embodiment, an additional Ethernet-OTN (EO) field can be added to the FlexO-MSI.ts to report whether a time slot is transporting Ethernet or OTN data. For example, in at least one embodiment setting an EO-0 bit 7 to a value of ‘1’ can be used to indicate that all 20 time slots are used in a bundle such that the mapping for a given FlexO-Xe frame is equivalent to have a 100 G granularity. This may help for interoperability with 400ZR.

In at least one embodiment, setting an EO-0 bit 7 to a value of ‘0’ can be used to indicate that FlexO-16e is based on 20 time slots. This may be useful to report whether the payload of a frame is Ethernet (where 100GE is mapped inside a single FlexO-Xe instance) or is an OTN frame where ODU4 does not fit inside a single FlexO-xe instance and involves reassembly (at the receiving device) based on time slots CSF-0/CSF-1/CSF-2 (client signal fail) transport up to 20 bits in which each time slot is dedicated to the transport of a client signal fail signal mapped over a specific time slot.

In various embodiments, enhanced Justification Control (JC) configurations for the FlexO-Xe frame structure 200 with 5 Gbit/s time slots can be provided as follows.

Further, embodiments herein may support enhanced JC1/JC2/JC3-JC4/JC5/JC6 signaling to enable 20 time slots support as provided by the FlexO-Xe frame structure utilizing 5 Gbit/s time slots.

Conventionally, JCx signals are transported by RESERVED bytes, Col-32/37. Justification is associated with time slots such that a multiframe alignment signal (MFAS) for a multiframe up to 24 FlexO can be requested.

For example, MFAS ‘0000 0000’ can be refereed to traffic transported by time slot 0, MFAS ‘0000 0001’ can be refereed to traffic transported by time slot 1, and so on such that MFAS ‘0010 0011’ can be refereed to traffic transported by time slot 19. In at least one embodiment, example JC configurations can be provided as shown below in TABLE 2, where a given column #of the FlexO-Xe frame structure 200 is referenced as ‘Col-#’.

TABLE 2
EXAMPLE JC CONFIGURATIONS

| | FlexO-Xe | | | | | | |
|---|---|---|---|---|---|---|---|
| MFAS | TS | Col-32 | Col-33 | Col-34 | Col-35 | Col-36 | Col-37 |
| 000000 | 0 | JC1 | JC2 | JC3 | JC4 | JC5 | JC6 |
| 000001 | 1 | JC1 | JC2 | JC3 | JC4 | JC5 | JC6 |
| 000010 | 2 | JC1 | JC2 | JC3 | JC4 | JC5 | JC6 |
| 000011 | 3 | JC1 | JC2 | JC3 | JC4 | JC5 | JC6 |
| 000100 | 4 | JC1 | JC2 | JC3 | JC4 | JC5 | JC6 |
| 000101 | 5 | JC1 | JC2 | JC3 | JC4 | JC5 | JC6 |
| 000110 | 6 | JC1 | JC2 | JC3 | JC4 | JC5 | JC6 |
| 000111 | 7 | JC1 | JC2 | JC3 | JC4 | JC5 | JC6 |
| 010000 | 8 | JC1 | JC2 | JC3 | JC4 | JC5 | JC6 |
| 010001 | 9 | JC1 | JC2 | JC3 | JC4 | JC5 | JC6 |
| 010010 | 10 | JC1 | JC2 | JC3 | JC4 | JC5 | JC6 |
| 010011 | 11 | JC1 | JC2 | JC3 | JC4 | JC5 | JC6 |
| 010100 | 12 | JC1 | JC2 | JC3 | JC4 | JC5 | JC6 |
| 010101 | 13 | JC1 | JC2 | JC3 | JC4 | JC5 | JC6 |
| 010110 | 14 | JC1 | JC2 | JC3 | JC4 | JC5 | JC6 |
| 010111 | 15 | JC1 | JC2 | JC3 | JC4 | JC5 | JC6 |
| 100000 | 16 | JC1 | JC2 | JC3 | JC4 | JC5 | JC6 |
| 100001 | 17 | JC1 | JC2 | JC3 | JC4 | JC5 | JC6 |
| 100010 | 18 | JC1 | JC2 | JC3 | JC4 | JC5 | JC6 |
| 100011 | 19 | JC1 | JC2 | JC3 | JC4 | JC5 | JC6 |
| 100100 | Not Used | | | | | | |
| 100101 | Not Used | | | | | | |
| 100110 | Not Used | | | | | | |
| 100111 | Not Used | | | | | | |
| 100000 | Not Used | | | | | | |
| 100001 | Not Used | | | | | | |
| 100010 | Not Used | | | | | | |
| 100011 | Not Used | | | | | | |
| 100100 | Not Used | | | | | | |
| 100101 | Not Used | | | | | | |
| 100110 | Not Used | | | | | | |
| 100111 | Not Used | | | | | | |

Accordingly, embodiments herein provide FlexO-16e.5Gts (FlexO optimized for Ethernet (FlexO-Xe) with 5 G time slots) solution that provides for the efficient transport of both Ethernet data and OTN data, or more generally, for any CBR data. In comparison to ITU-T BIT standards-proposed solutions, the FlexO-Xe frame structure 200 utilizing 5 Gbit/s time slots may support 15×ODU4, whereas currently proposed ITU-T BIT solutions only support 8×ODU4. Thus, the FlexO-16e.5Gts solution provided herein may offer to transport double the amount of ODU4 data compared to current ITU-T BIT solutions.

The Multiplex Structure Identifier (MSI) as discussed for embodiments herein is specifically designed for 5 G time slots to have more flexibility in mixing Ethernet and OTN clients in the 1.6 T line side stream. Further, the time slot block size being based on 257 bits (same block size for OTN and Ethernet) is provided to harmonize incoming Ethernet and OTN clients towards the line side.

Additionally, enhanced JC1/JC2/JC3-JC4/JC5/JC6 allocation for the 5 Gbit/s time slot granularity and novel techniques for transporting GMP information for each time slot is provided in accordance with embodiments herein. Further, embodiments herein may facilitate the agnostic transport of any traffic with a 5 Gbit/s granularity utilizing the FlexO-Xe data frame structure.

Moreover, the FlexO-16e.5ts frame mapping techniques as provided in accordance with embodiments herein may provide similar functionality and the time slot granularity as ODUC16. For this reason, use of FlexO-16e.5ts may obsolete the use of ODUC16 or, more generally, may allow for the elimination of the ODUCn layer, similar to what is proposed in some BIT solutions in the ITU. Further, all functionalities and fine granularity of ODUCn can be supported by the FlexO-16e.5ts frame mapping techniques.

Further, the FlexO-Xe with 5 Gbit/s frame mapping techniques as provided through embodiments herein preserves the ODU4/ODUCn framing structure and proposes a mapping structure that is significantly more efficient than traditional mapping at a lower baud rate. Through embodiments herein, ODU4/ODUCn mapping is 93.8% efficient at a ~240 G baud rate (1.6 T transmission rate), whereas traditional mapping would result in either 5% higher baud rate at 100% mapping efficiency or 50% mapping efficiency into the lower, Ethernet optimized, FlexO-Xe rate. Thus, at 1.6 T the more efficient mapping as provided through embodiments herein is 93.8% efficient at 5% lower baud rate compared to the traditional OTN hierarchy, which may advantageously provide greater reach while protecting existing infrastructure investments.

It is noted that the example frame mapping techniques as illustrated in FIG. 4 and FIG. 5 are provided for illustration only and are not meant to limit the broad scope of embodiments herein. More generally, it is to be understood that 100GE data can be mapped over any 20×5 Gbit/s time slot blocks and ODU4 data can be mapped over any 21×5 Gbit/s time slot blocks utilizing the FlexO-Xe frame structure 200, in accordance with embodiments herein. Stated differently, any CBR data can be mapped into an ‘M’×5 Gbit/s time slot blocks utilizing the FlexO-Xe frame structure 200, in accordance with embodiments herein.

Further, although FlexO.1e #0 thru Flex.1e #14 are identified as the subset of the total number of 16 channelized data frames in which ODU4 data is directly mapped into 20 time slots of each time slot block group, it is to be understood that embodiments herein envision that any combination of a number channelized data frames may be used as the subset of a total number of channelized data frames to support 15×ODU4.

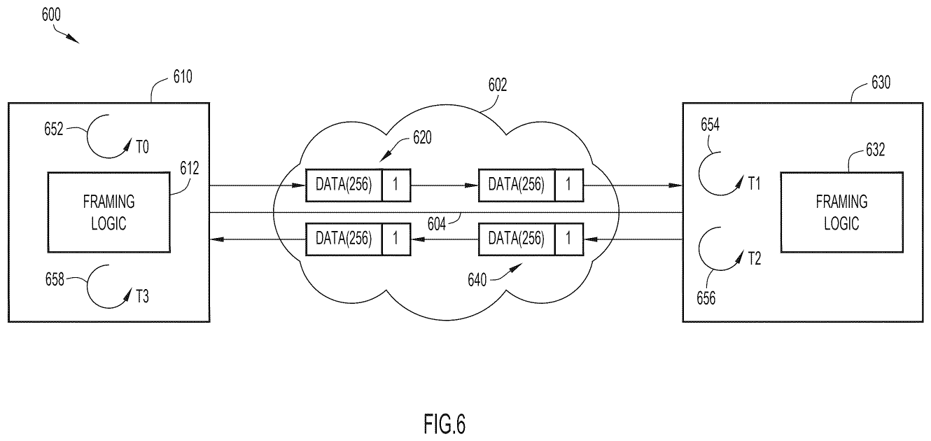

Referring to FIG. 6, FIG. 6 is a block diagram of a system 600 illustrating example operations that may facilitate measuring round trip latency when transporting OTN data, such as ODU4 data, via channelized FlexO-Xe data frames utilizing 5 Gbit/s time slots, according to an example embodiment.

As shown in FIG. 6 (and similar to system 100), system 600 may include a network device, referred to as near end 610, including framing logic 612, a network device, referred to in FIG. 6 as far end 630, including framing logic 632, and a network 602 through which near end 610 and far end 630 may interface via at least one optical link 604.

As noted herein, in some embodiments, OTN (e.g., ODU4) data can be carried in an enhanced 257-bit time slot block structure (e.g., enhanced TS block structure 224′, as shown in FIG. 2) in which 256-bits can be used for OTN payload and one stuffing bit can be used for other purposes. For example, transporting OTN data as 256/257 bits block offers the opportunity to measure, with high accuracy, the round-trip latency between endpoints, such as between near end 610 and far end 630 as shown in FIG. 6.

As illustrated in FIG. 6, to initiate a round-trip latency measurement, as generally shown at 652, the near end 610 sets the stuffing bit in one or more 5 Gbit/s time slots of channelized FlexO-Xe OTN data frames 620 that are transmitted to the far end 630 (i.e., bit 257 of each time slot block) to a value of ‘1’ and initiates an internal timer, for example starting the timer at a time TO. The OTN data (e.g., ODU4 data) can be carried in the 256 payload of each times lot block, as discussed for embodiments herein.

The stuffing bit for transmitted data frames may be set to a value of ‘0’ by default (for both near and far end devices) such that a given network device can determine to initiate a round-trip latency measurement according to policy, periodically (e.g., ever ‘X’ seconds/milliseconds, etc.), upon detecting errors in data frames, combinations thereof, and/or the like.

As generally illustrated 654, the channelized FlexO-Xe data frames 620 can be received by the far end 630 via the at least one optical link 604 and the far end 630 can check the stuffing bit in the time slot(s) of the received FlexO-Xe data frames 620 to detect the stuffing bit being set to the value of ‘1’ in the one or more time slot blocks of the received data frames 620, say at a time T1. As generally illustrated at 656, upon detecting the stuffing bit being set to the value of ‘1’ in the one or more time slot blocks of the received data frames 620, say, at a time T2, the far end 630 can automatically start to insert (replay) the value of ‘l’ into the stuffing bit of one or more time slot blocks of channelized FlexO-Xe OTN data frames 640 that are transmitted in the reverse direction to the near end 610 via the at least one optical link 604.

As generally illustrated at 658, upon the near end 610 receiving the channelized FlexO-Xe OTN data frames 640 the near end 610 can check the stuffing bit in the time slot(s) of the received FlexO-Xe data frames 640 to detect the stuffing bit of one or more time slot blocks being set to the value of ‘1’. Upon detecting the stuffing bit of a given time slot block being set to the value of ‘1’, the near end 610 stops the timer, say at a time T3, and can calculate the round-trip latency, such as calculating (Round-Trip Latency=(T3−T0)−(T2−T1)). The value (T2−T1) may represent the processing delay for detection of the stuffing bit for incoming data frames and marking setting the stuff bit of transmitted data frames.

Thus, the stuffing bits of time slot blocks of OTN data (or any other data that may not utilize all 257 bits of each time slot block of channelized FlexO-Xe) data frames can be used to measure round-trip latency between network devices at a good accuracy.

At 100 G, the inaccuracy introduced by the round-trip measurement techniques provided herein may be approximately <2.5 nanoseconds (nsec). OTN has an error of at least one ODUk frame such that the error is 257 bits. In comparison, the round-trip latency measurement as provided via embodiments herein is approximately 500 times more accurate as compared with standardized G.709 measurements. Thus, embodiments herein may facilitate accurate latency measurements and, moreover, the accurate low latency measurements (in the order of a few nanoseconds) may achieve best in class latency measurement on the protocol layer.

In at least one embodiment, accuracy for the round-trip latency measurement provided herein can be improved by synchronization of the near and the far end. In this manner, the transmitting (TX) side can receive back the message that it originated and can measure the round-trip delay using the stuffing bit technique as provided herein.

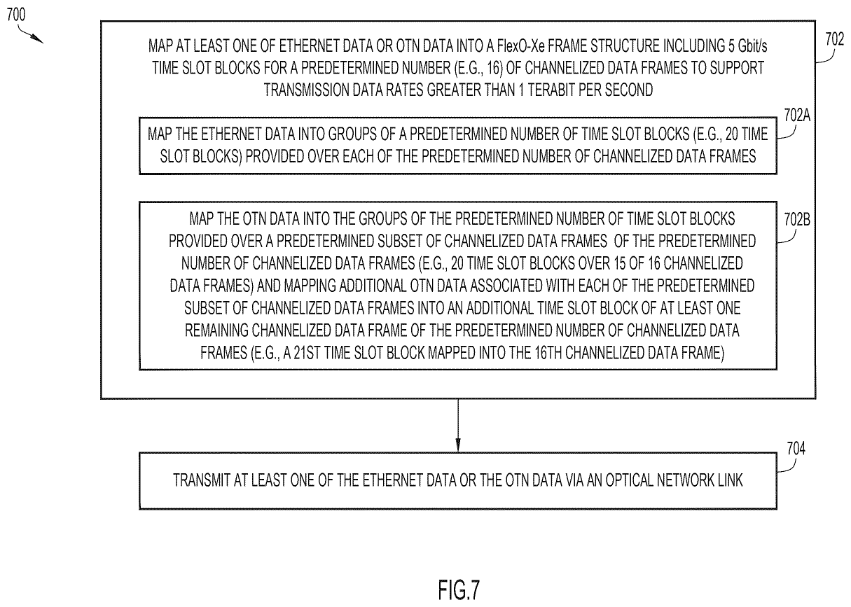

Referring to FIG. 7, FIG. 7 is a flow chart depicting a method 700, according to an example embodiment. In at least one embodiment, method 700 illustrates operations that may be performed at least in part by a network device, via framing logic configured for the network device, such as any of network device 110, network device 130, near end 610, and/or far end 630 in order to map CBR data, such as Ethernet and OTN (ODU4) data utilizing the FlexO-Xe framing structure as provided herein, according to an example embodiment.

A 702, the method may include mapping at least one of Ethernet data or OTN data into a FlexO-Xe frame structure including 5 Gbit/s time slot blocks for a predetermined number of channelized data frames (e.g., 16 FlexO-Xe frames or FlexO.16e) to support transmission data rates greater than 1 Terabit per second.

As shown at 702A, for Ethernet data, the mapping may include mapping the Ethernet data into groups of a predetermined number of time slot blocks (e.g., groups of 20 time slot blocks) provided over each of the predetermined number (e.g., 16) of channelized data frames.

As shown at 702B, for OTN data, the mapping may include mapping the OTN data into the groups of the predetermined number of time slot blocks provided over a predetermined subset of channelized data frames of the predetermined number of channelized data frames (e.g., OTN data being mapped into 20 time slot blocks for a given group number of 15 channelized FlexO-Xe data frames) and mapping additional OTN data associated with each of the predetermined subset of channelized data frames into an additional time slot block of at least one remaining channelized data frame of the predetermined number of channelized data frames (e.g., additional OTN data associated with each of the 15 channelized FlexO-Xe being mapped into a 21^{st} time slot block for the given group number for the 16^{th} channelized data frame).

As shown at 704, the method may include transmitting at least one of the Ethernet data or the OTN data via an optical network link (e.g., via the channelized FlexO-Xe data frames transmitted via at least one optical network link).

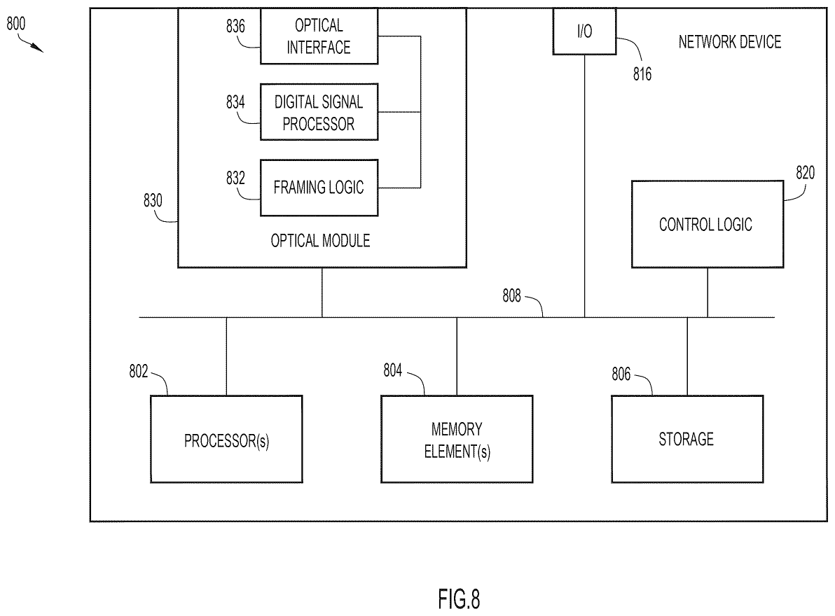

Referring to FIG. 8, FIG. 8 illustrates a hardware block diagram of a network device 800 that may perform functions associated with operations discussed herein in connection with the techniques described for embodiments herein. In various embodiments, a network device or apparatus, such as network device 800 or any combination of network devices 800, may be configured as any entity/entities in order to perform operations of the various techniques discussed for embodiments herein as discussed with reference to FIGS. 1-7, such as any elements, functions, etc. discussed for embodiments herein (e.g., network device 110, network device 130, near end 610, and/or far end 630).

In at least one embodiment, the network device 800 may be any apparatus that may include one or more processor(s) 802, one or more memory element(s) 804, storage 806, a bus 808, one or more I/O interface(s) 816, control logic 820, and an optical module 830. Optical module 830 may include frame logic 832, a digital signal processor (DSP) 834, and an optical transceiver or interface 836. In various embodiments, instructions associated with logic for network device 800 can overlap in any manner and are not limited to the specific allocation of instructions and/or operations described herein.

In at least one embodiment, processor(s) 802 is/are at least one hardware processor configured to execute various tasks, operations and/or functions for network device 800 as described herein according to software and/or instructions configured for network device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with network device 800, and/or logic configured for memory element(s) 804 and/or storage 806. For example, any logic described herein (e.g., control logic 820 and framing logic 832) can, in various embodiments, be stored for network device 800 using any combination of memory element(s) 804 and/or storage 806, either or both of which may also be provided for optical module 830. Note that in some embodiments, storage 806 can be consolidated with memory element(s) 804 (or vice versa) or can overlap/exist in any other suitable manner.

In at least one embodiment, bus 808 can be configured as an interface that enables one or more elements of network device 800 to communicate in order to exchange information and/or data. Bus 808 can be implemented with any architecture designed for passing control, data and/or information between processors, memory elements/storage, peripheral devices, and/or any other hardware and/or software components that may be configured for network device 800. In at least one embodiment, bus 808 may be implemented as a fast kernel-hosted interconnect, potentially using shared memory between processes (e.g., logic), which can enable efficient communication paths between the processes.

In various embodiments, optical module 830 may enable optical communications via one or more optical network links. Optical module 830 includes optical interface 836, which may include an optical transceiver (e.g., optical driver(s) and/or controller(s)) configured to enable optical module 830, via framing logic 832 and digital signal processor 834, to transmit/receive optical signals to/from an optical medium. In various embodiments, optical interface 836 may include the optical transceiver that includes an optical transmitter to convert electrical signals (e.g., in digital form) to optical signals and transmit the optical signals over an optical medium and an optical receiver to convert optical signals received over the optical medium to electrical signals (e.g., in digital form). In various embodiments, digital signal processor 834 can perform any signal processing operations in conjunction with and/or in combination with optical interface 836 and framing logic 832, such as analog to digital signal conversion, digital to analog signal conversion, sampling, filtering, etc.

In various embodiments, framing logic 832 can be implemented as and/or may include GMP controllers that, in the transmit direction, can be configured to receive data traffic (e.g., Ethernet and/or OTN client traffic) and convert or map the data into channelized FlexO-Xe data frames including 5 Gbit/s time slots in accordance with embodiments herein that can be transmitted via operations performed by digital signal processor 834 and optical interface 836. In the receive direction, for optical signals received via optical interface 836 and converted into electrical signals, potentially through operations performed via digital signal processor 834, framing logic 832 operates to demap or recover data traffic carried via channelized FlexO-Xe data frames (e.g., performing reverse processing as performed for mapping data into the channelized FlexO-Xe) data frames. In various embodiments, optical module 830 may be configured as part of network device 800 or may be configured as an external module that interfaces with network device.

I/O interface(s) 816 allow for input and output of data and/or information with other entities that may be connected to network device 800. For example, I/O interface(s) 816 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 820 can include instructions that, when executed, cause processor(s) 802 to perform operations, which can include, but not be limited to, providing overall control operations of network device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820 and framing logic 832) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a network device for transfer onto another computer readable storage medium.

In one form, a computer-implemented method is provided that may include mapping at least one of Ethernet data or OTN data into a FlexO-Xe frame structure across a predetermined number of channelized data frames (e.g., 16 FlexO-Xe frames or FlexO.16e) to support transmission data rates greater than 1 Terabit per second.

In one form, a computer-implemented method is provided that may include mapping at least one of Ethernet data or optical transport network (OTN) data into a flexible optical transport network (OTN) optimized for Ethernet (FlexO-Xe) frame structure including 5 Gigabit per second time slot blocks for a predetermined number of channelized data frames to support transmission data rates greater than 1 Terabit per second, wherein the mapping includes: mapping the Ethernet data into groups of a predetermined number of time slot blocks provided over each of the predetermined number of channelized data frames; and mapping the OTN data into the groups of the predetermined number of time slot blocks provided over a predetermined subset of channelized data frames of the predetermined number of channelized data frames and mapping additional OTN data associated with each of the predetermined subset of channelized data frames into an additional time slot block of at least one remaining channelized data frame of the predetermined number of channelized data frames; and transmitting at least one of the Ethernet data or the OTN data via an optical network link.

In one instance, each group of the predetermined number of time slot blocks includes 20 time slot blocks and wherein each channelized data frame includes 2555 time slot blocks including the Ethernet data or the OTN data. In one instance, the predetermined number of channelized data frames is 16 channelized data frames and the predetermined subset of the channelized data frames is 15 channelized data frames of the 16 channelized data frames.

In one instance, mapping for the Ethernet data supports transmitting the Ethernet data at a rate of 1.6 Terabit per second utilizing the predetermined number of channelized data frames and the mapping for the OTN data supports transmitting the OTN data at a rate of 1.575 Terabit per second utilizing the predetermined number of channelized data frames.

In one instance, the FlexO-Xe frame structure including the 5 Gigabit per second time slot blocks supports mapping constant bit rate (CBR) data into the predetermined number of channelized data frames including the groups of the predetermined number of time slot blocks.

In one instance, for mapping the Ethernet data, each time slot block is capable of transporting 257 bits of Ethernet data. In one instance, the OTN data is optical data unit type 4 (ODU4) data provided at a rate of 105 Gigabit per second. In one instance, for mapping the OTN data, each time slot block is capable of transporting 256 bits of OTN data and a stuffing bit.

In one form, the method may include transmitting is performed by a source device for transmitting the OTN data via the optical network link to a destination device, the method further comprising: setting the stuffing bit in one or more time slot blocks by the source device to a value of ‘1’ to facilitate measuring round-trip latency between the source device and the destination device; and initiating a timer. In one instance, the method may further include receiving OTN data by the source device from destination device; checking a value of the stuffing bit in the one or more time slot blocks of OTN data received from the destination device; upon determining that the value of the stuffing bits in the time slot blocks of the OTN data is set to a value of ‘1’, stopping the timer; and calculating a transmission latency between the source device and the destination device based, at least in part, on a start time and an end time of the timer.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
mapping at least one of Ethernet data or optical transport network (OTN) data into a flexible optical transport network (OTN) optimized for Ethernet (FlexO-Xe) frame structure including 5 Gigabit per second time slot blocks for a predetermined number of channelized data frames to support transmission data rates greater than 1 Terabit per second, wherein the mapping includes:
mapping the Ethernet data into groups of a predetermined number of time slot blocks provided over each of the predetermined number of channelized data frames; and
mapping the OTN data into the groups of the predetermined number of time slot blocks provided over a predetermined subset of channelized data frames of the predetermined number of channelized data frames and mapping additional OTN data associated with each of the predetermined subset of channelized data frames into an additional time slot block of at least one remaining channelized data frame of the predetermined number of channelized data frames; and
transmitting at least one of the Ethernet data or the OTN data via an optical network link.

2. The method of claim 1, wherein each group of the predetermined number of time slot blocks includes 20 time slot blocks and wherein each channelized data frame includes 2555 time slot blocks including the Ethernet data or the OTN data.

3. The method of claim 1, wherein the predetermined number of channelized data frames is 16 channelized data frames and the predetermined subset of the channelized data frames is 15 channelized data frames of the 16 channelized data frames.

4. The method of claim 1, wherein the mapping for the Ethernet data supports transmitting the Ethernet data at a rate of 1.6 Terabit per second utilizing the predetermined number of channelized data frames and the mapping for the OTN data supports transmitting the OTN data at a rate of 1.575 Terabit per second utilizing the predetermined number of channelized data frames.

5. The method of claim 1, wherein the FlexO-Xe frame structure including the 5 Gigabit per second time slot blocks supports mapping constant bit rate (CBR) data into the predetermined number of channelized data frames including the groups of the predetermined number of time slot blocks.

6. The method of claim 1, wherein for mapping the Ethernet data, each time slot block is capable of transporting 257 bits of Ethernet data.

7. The method of claim 1, wherein the OTN data is optical data unit type 4 (ODU4) data provided at a rate of 105 Gigabit per second.

8. The method of claim 1, wherein for mapping the OTN data, each time slot block is capable of transporting 256 bits of OTN data and a stuffing bit.

9. The method of claim 8, wherein when the transmitting is performed by a source device for transmitting the OTN data via the optical network link to a destination device, the method further comprising:
setting the stuffing bit in one or more time slot blocks by the source device to a value of ‘1’ to facilitate measuring round-trip latency between the source device and the destination device; and
initiating a timer.

10. The method of claim 9, further comprising:
receiving OTN data by the source device from destination device;
checking a value of the stuffing bit in the one or more time slot blocks of OTN data received from the destination device;
upon determining that the value of the stuffing bits in the time slot blocks of the OTN data is set to a value of ‘1’, stopping the timer; and
calculating a transmission latency between the source device and the destination device based, at least in part, on a start time and an end time of the timer.

11. One or more non-transitory computer readable storage media encoded with instructions that, when executed by a processor, cause the processor to perform operations, comprising:
mapping at least one of Ethernet data or optical transport network (OTN) data into a flexible optical transport network (OTN) optimized for Ethernet (FlexO-Xe) frame structure including 5 Gigabit per second time slot blocks for a predetermined number of channelized data frames to support transmission data rates greater than 1 Terabit per second, wherein the mapping includes:
mapping the Ethernet data into groups of a predetermined number of time slot blocks provided over each of the predetermined number of channelized data frames; and
mapping the OTN data into the groups of the predetermined number of time slot blocks provided over a predetermined subset of channelized data frames of the predetermined number of channelized data frames and mapping additional OTN data associated with each of the predetermined subset of channelized data frames into an additional time slot block of at least one remaining channelized data frame of the predetermined number of channelized data frames; and
transmitting at least one of the Ethernet data or the OTN data via an optical network link.

12. The media of claim 11, wherein each group of the predetermined number of time slot blocks includes 20 time slot blocks and wherein each channelized data frame includes 2555 time slot blocks including the Ethernet data or the OTN data.

13. The media of claim 11, wherein the predetermined number of channelized data frames is 16 channelized data frames and the predetermined subset of the channelized data frames is 15 channelized data frames of the 16 channelized data frames.

14. The media of claim 11, wherein the FlexO-Xe frame structure including the 5 Gigabit per second time slot blocks supports mapping constant bit rate (CBR) data into the predetermined number of channelized data frames including the groups of the predetermined number of time slot blocks.

15. The media of claim 11, wherein for mapping the Ethernet data, each time slot block is capable of transporting 257 bits of Ethernet data.

16. The media of claim 11, wherein for mapping the OTN data, each time slot block is capable of transporting 256 bits of OTN data and a stuffing bit.

17. An apparatus comprising:
at least one memory element for storing data; and
at least one processor for executing instructions associated with the data, wherein executing the instructions causes the apparatus to perform operations, comprising:
mapping at least one of Ethernet data or optical transport network (OTN) data into a flexible optical transport network (OTN) optimized for Ethernet (FlexO-Xe) frame structure including 5 Gigabit per second time slot blocks for a predetermined number of channelized data frames to support transmission data rates greater than 1 Terabit per second, wherein the mapping includes:
mapping the Ethernet data into groups of a predetermined number of time slot blocks provided over each of the predetermined number of channelized data frames; and
mapping the OTN data into the groups of the predetermined number of time slot blocks provided over a predetermined subset of channelized data frames of the predetermined number of channelized data frames and mapping additional OTN data associated with each of the predetermined subset of channelized data frames into an additional time slot block of at least one remaining channelized data frame of the predetermined number of channelized data frames; and
transmitting at least one of the Ethernet data or the OTN data via an optical network link.

18. The apparatus of claim 17, wherein each group of the predetermined number of time slot blocks includes 20 time slot blocks and wherein each channelized data frame includes 2555 time slot blocks including the Ethernet data or the OTN data.

19. The apparatus of claim 17, wherein the predetermined number of channelized data frames is 16 channelized data frames and the predetermined subset of the channelized data frames is 15 channelized data frames of the 16 channelized data frames.

20. The apparatus of claim 17, wherein for mapping the OTN data, each time slot block is capable of transporting 256 bits of OTN data and a stuffing bit.
